(19) United States
(12) Patent Application Publication
(10) Pub. No.: US 2026/0079123 A1
(43) Pub. Date: Mar. 19, 2026

(54) Systems and Methods for Detection of Phases and Phase Transitions in Some Materials

(71) Applicant: Trustees of Tufts College, Boston, MA (US)

(72) Inventors: John J. THOMAS, Boston, MA (US); Peggy CEBE, Boston, MA (US); Alexis Philip RALLI, Medford, MA (US)

(73) Assignee: Trustees of Tufts College, Boston, MA (US)

(21) Appl. No.: 19/331,912

(22) Filed: Sep. 17, 2025

Related U.S. Application Data
(60) Provisional application No. 63/696,100, filed on Sep. 18, 2024.

(51) Int. Cl. G01N 25/12; G01N 1/44; G01N 25/04

(52) U.S. Cl. CPC G01N 25/12; G01N 1/44; G01N 25/04

(57) ABSTRACT

A system comprising a sample heater configured to heat a sample and to determine a plurality of heat amounts applied to the sample at a plurality of times in a time interval; a temperature sensor configured to determine a plurality of temperatures of the sample at the plurality of times; and an analyzer module configured to: receive information indicating the plurality of heat amounts and the plurality of temperatures as functions of the plurality of times; and identify at least one phase transition in the sample during the time interval.

### STATEMENT REGARDING FEDERALLY SPONSORED RESEARCH OR DEVELOPMENT

This invention was made with government support under DMR-2003629 awarded by the National Science Foundation. The government has certain rights in the invention.

### TECHNICAL FIELD

The present disclosure relates generally to detecting phase transitions in materials such as polymers and particularly to quality control during manufacturing of such materials.

### BACKGROUND

The determination of thermal properties in materials such as polymers plays an important role in controlling the quality of these materials during manufacturing and also in determining the range of conditions in which they can be utilized optimally. While this determination heavily relies on precise calorimetric measurements, presently it also requires human intervention to identify transition regions. Such interventions often include a subjective assessment or “eye test.” Some technologies may utilize techniques such as differential scanning calorimetry (DSC) or fast scanning DSC (FSC) to measure key dynamics such as the glass transition or crystalline melt. However, these dynamics often span a large temperature range, making the pinpointing of their onsets challenging. The human interventions, on the other hand, introduce multiple problems such as imprecision, being subjective and thus non-reproducible, being slow and cumbersome, and therefore unscalable. Due to these weaknesses, existing techniques for detecting phase transitions in materials are not suitable for industrial applications, which often require precision, being objective and reproducible, and amenable to being performed in large numbers during short periods of time.

### SUMMARY

Some embodiments relate to a system including: a sample heater configured to heat a sample and to determine a plurality of heat amounts applied to the sample at a plurality of times in a time interval; a temperature sensor configured to determine a plurality of temperatures of the sample at the plurality of times; and an analyzer module configured to: receive information indicating the plurality of heat amounts and the plurality of temperatures as functions of the plurality of times; and identify at least one phase transition in the sample during the time interval.

Some embodiments relate to a system, wherein the analyzer module is further configured to: determine a heat capacity-temperature dependence including a plurality of heat capacity values as a function of the plurality of temperatures; and compare the heat capacity-temperature dependence with a reference dependence relationship to identify the at least one phase transition.

Some embodiments relate to a system, wherein the dependence relationship includes a first linear dependence on the temperature, a second linear dependence on the temperature, and a nonlinear dependence on the temperature connecting the first linear dependence to the second linear dependence.

Some embodiments relate to a system, wherein the comparing identifies an event.

Some embodiments relate to a system, wherein the event includes a second order phase transition.

Some embodiments relate to a system, wherein the second order phase transition includes a glass transition.

Some embodiments relate to a system, wherein the event includes a first order phase transition.

Some embodiments relate to a system, wherein the first order phase transition includes melting.

Some embodiments relate to a system, wherein: the dependence relationship includes a linear dependence; and the analyzer module is further configured to: determine a maximum range for fitting the heat capacity-temperature dependence with the linear dependence; and accordingly determine an onset of a glass transition.

Some embodiments relate to a system, wherein the analyzer module is further configured to determine an end of the glass transition based on a point of a minimum fit.

Some embodiments relate to a method for determining phase transitions of a sample over a temperature range, including using a microprocessor to perform: identifying a plurality of phases of the sample and their relative order as a function of temperature over a temperature range; receiving heat-temperature data corresponding to temperature of the sample at a plurality of temperature values and values of a heat-related variable indicative of an amount of heat required to raise a temperature of the sample to each of the temperature values; identifying a transition between at least two of the phases by fitting the heat-temperature data as a function of increasing or decreasing temperature to a reference functional profile; and utilizing a defined quality of fit criterion to identity at least one temperature associated with the transition.

Some embodiments relate to a method, wherein the heat-related variable includes a heat capacity of the sample.

Some embodiments relate to a method, wherein: a first one of the at least two phases is characterized by a linear relationship between the heat capacity and the temperature; and a second one of the at least two phases is a rubbery/semi-solid phase separated from the first phase by a glass transition.

Some embodiments relate to a method, wherein: the reference functional profile includes a linear section; and the quality of fit criterion is a linear fit.

Some embodiments relate to a method including: utilizing an analyzer module for performing: receiving information including: a plurality of heat amounts applied to a sample at a plurality of times in a time interval; and a plurality of temperatures of the sample at the plurality of times; and identifying at least one phase transition in the sample during the time interval based on a relation between the plurality of heat amounts and the plurality of temperatures.

Some embodiments relate to a method, further including: utilizing a sample heater to heat the sample and to determine the plurality of heat amounts applied to the sample at the plurality of times; and utilizing a temperature sensor to determine the plurality of temperatures of the sample at the plurality of times.

Some embodiments relate to a method, further utilizing the analyzer module to perform: determining a heat capacity-temperature dependence including a plurality of heat capacity values as a function of the plurality of temperatures; and comparing the heat capacity-temperature dependence with a reference dependence relationship to identify the at least one phase transition.

Some embodiments relate to a method, wherein the dependence relationship includes a first linear dependence on the temperature, a second linear dependence on the temperature, and a nonlinear dependence on the temperature connecting the first linear dependence to the second linear dependence.

Some embodiments relate to a method, wherein the comparing identifies an event.

Some embodiments relate to a method, wherein the event includes a second order phase transition.

Some embodiments relate to a method, wherein the second order phase transition includes a glass transition.

Some embodiments relate to a method, wherein the event includes a first order phase transition.

Some embodiments relate to a method, wherein the first order phase transition includes a melting.

Some embodiments relate to a method, wherein: the dependence relationship includes a linear dependence; and the method further includes utilizing the analyzer module to perform: determining a maximum range for fitting the heat capacity-temperature dependence with the linear dependence; and accordingly determining an onset of a glass transition.

Some embodiments relate to a method, the method further including utilizing the analyzer module to perform determining an end of the glass transition based on a point of a minimum fit.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1A is a block diagram of a quality control system 100 for determining details of phases or phase transitions in a sample according to some embodiments.

FIG. 1B is a flowchart 150 depicting the improvements in quality control of samples according to some embodiments.

FIG. 2 is a graph diagram 200 of apparent heat capacity of a sample as a function of temperature as utilized by some embodiments.

FIG. 3 shows four heat capacity diagrams corresponding to three different cases of heating segments according to different embodiments.

FIG. 4 shows application of three different convolution kernels for detecting three different types of phase transitions according to some embodiments.

FIG. 5A shows four different examples of convolution analysis of simulated heat capacity data according to some embodiments.

FIG. 5B shows four different examples of convolution analysis of experimental heat capacity data derived for the PLLA sample according to an embodiment.

FIG. 6 shows the normalized first and second derivatives of the apparent heat capacity with respect to temperature, as utilized by some embodiments.

FIG. 7 includes a graph set 700, which demonstrates some results of the linear fit analysis performed on the heat capacity data according to some embodiments.

FIG. 8 includes a graph set 800 that illustrates the liquid state fitting according to some embodiments.

FIG. 9 shows a graph set 900, which illustrates the difference between the conventional method and the improved techniques according to some embodiments.

FIGS. 10A and 10B illustrate some of the improvements achieved in determination of the total melting heat utilizing the new techniques according to some embodiments.

FIG. 11 schematically depicts an example of an implementation of a module 1100 according to some embodiments.

### DETAILED DESCRIPTION

The following detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

To address the above problems of conventional methods, various embodiments utilize a robust automated method for heat capacity analysis of polymeric systems, capable of determining these key properties without the need for user input. The determination of thermal properties in polymers relies heavily on precise calorimetric measurements. Techniques such as differential scanning calorimetry (DSC) or fast scanning DSC (FSC) are used to measure key dynamics such as the glass transition or crystalline melt. However, these dynamics often span a large temperature range, making the pinpointing of their onsets challenging.

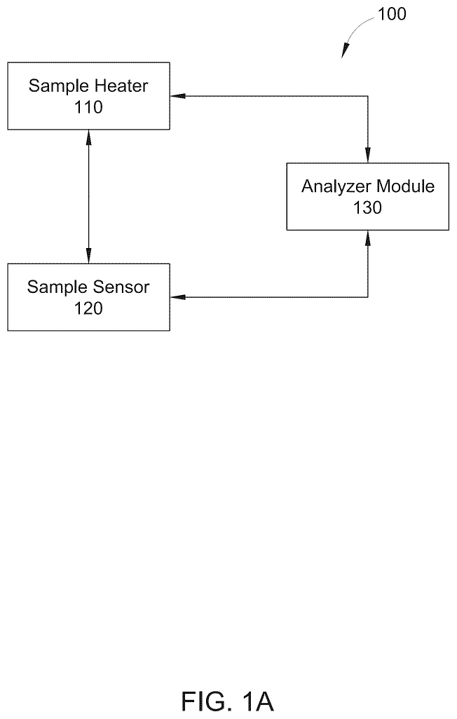

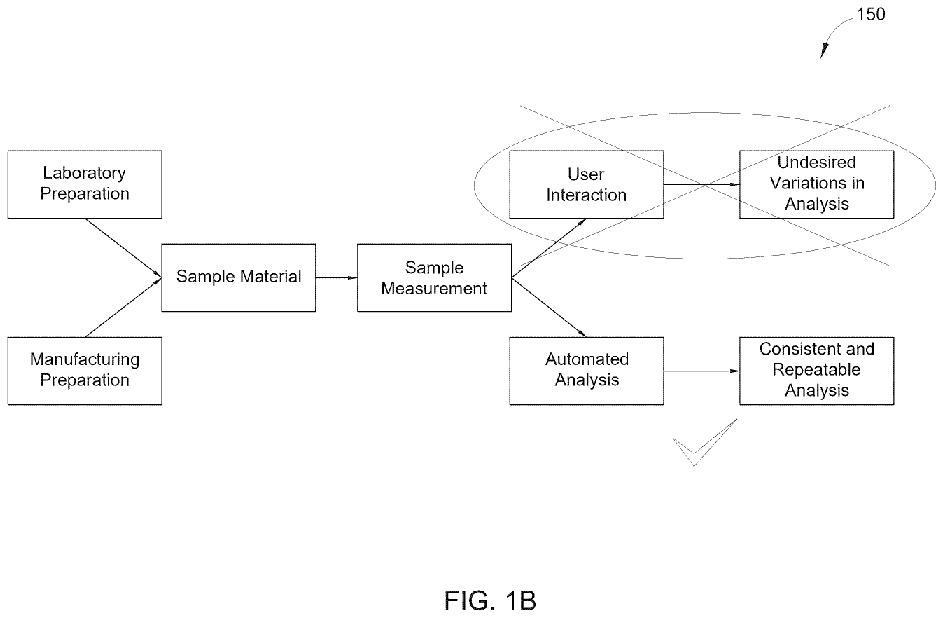

FIG. 1A is a block diagram of a quality control system 100 for determining details of phases or phase transitions in a sample according to some embodiments. System 100 includes a sample heater 110, a sample sensor 120, and an analyzer module 130.

Sample heater 110 may be configured to heat the sample during a time interval. Moreover, sample heater 110 may be further configured to measure the amount of heat applied to the sample up to different times during the time interval. In some embodiments, sample heater 110 records the amount of heat in a unit such as Jules or calories as a function of time.

Sample sensor 120 is configured to detect one or more physical characteristics of the sample while sample heater 110 heats the sample. Sample sensor 120 may, for example, detect the temperature of the sample as a function of time. The temperature may be recorded in units such as Kelvin, Celsius, or Fahrenheit.

Analyzer module 130 is configured to receive various data from sample heater 110 or sample sensor 120 and analyze those data. Analyzer module 130, for example, may receive data related to the amount of heat applied to the sample and the corresponding temperature of the sample at each time. Analyzer module 130 may further utilize the data to determine, for example, the heat capacity of the sample as a function of time or as a function of its temperature. In various embodiments, the heat capacity may be calculated as the amount of heat required to increase the temperature of the sample by one unit of temperature. Moreover, analyzer module 130 may analyze the received data to determine the phase of the sample or occurrence of phase transitions in the sample as a function of time or as a function of temperature, as further detailed below.

FIG. 1B is a flowchart 150 depicting the improvements in quality control of samples according to some embodiments. More specifically, flowchart 150 demonstrates that a sample may be prepared in a laboratory or in a manufacturing facility. Further, the sample may be analyzed using a quality control system such as system 100. In the conventional systems, the quality control system may have been limited by requiring interactions with one or more users and subjective determination of phases or phase transitions by the user. The conventional systems, therefore, suffered from various shortcomings including low speed (and therefore inability to perform the quality control on an industrial scale), inaccuracy, high cost of requiring human interactions, inability to be reproduced, and thus being unreliable. The improved systems according to various embodiments, on the other hand, are able to avoid utilizing the user's subjective and imprecise judgment, and instead utilize automated systems such as system 100. These systems, as also further explained below, provide improvements such as high speed, repeatability, accuracy, reproducibility, and therefore reliability in, for example, high scale industrial or high accuracy critical applications.

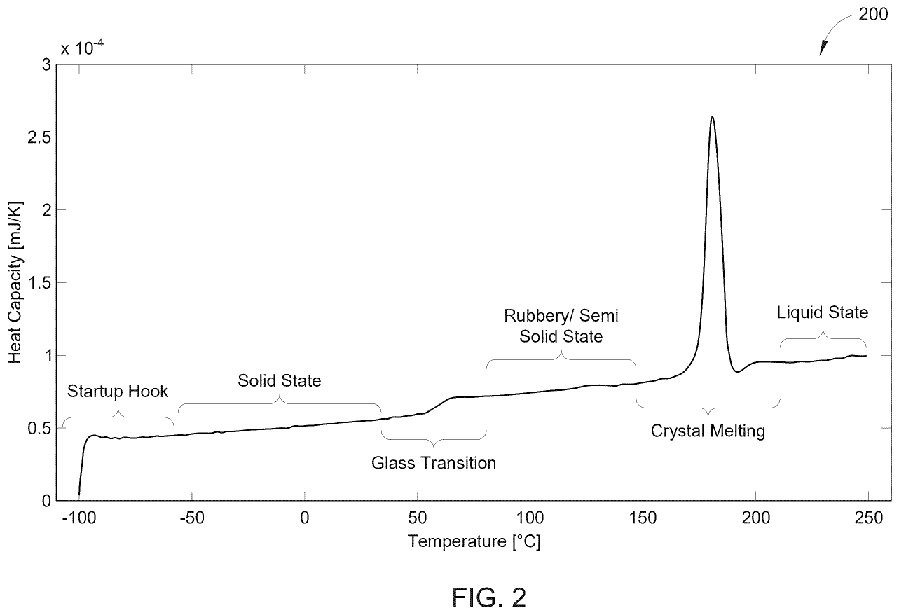

FIG. 2 is a graph diagram 200 of apparent heat capacity of a sample as a function of temperature as utilized by some embodiments.

More specifically, diagram 200 shows a graph of the heat capacity of a sample containing poly(l-lactic acid), PLLA. In the graph, different regions are marked, some corresponding to regions of different phases or phase transitions for the sample. In particular, the consecutive regions from left are marked, respectively, the startup hook region, the solid-state region, the glass transition region, the rubbery/semi-solid state region, the crystal melt region, and the liquid state region. In some embodiments, these regions may be determined using one or more of the techniques described below. In various embodiments, the following techniques may be performed by the analyzer module.

Regarding the startup hook region, some embodiments may remove this region from the data before analyzing the data, for different reasons. For example, the existence, range, and amount of heat capacity in this region may depend on factors that are specific to each case of heating the sample. Those factors may include, for example, the heating rate, the material thickness, or the presence or absence of an isothermal hold at the turning point prior to heating. Therefore, the data in the startup hook region may not be reliable for deriving general repeatable characteristics of the sample.

To identify the startup hook region various embodiments may utilize different techniques. Some embodiments may utilize a special function for estimating the length of the startup hook region based on the type of experiment (e.g., FSC or DSC), the heating rate, and the existence or absence of a prior isothermal hold.

In some embodiments, for example, those that perform the DSC type of heating, the startup hook region may be identified based on the heating rate. For example, in some embodiments, if the heating rate is x degrees centigrade per minute, the startup hook may be identified as the first x degrees at the start of the data. Specifically, if the sample is heated at the heating rate of, for example, 20° C./min, the first 20° C. on the horizontal temperature axis may be identified as the startup hook region and may be trimmed. In some embodiments, a padding factor, such as another 2° C. is used so 22° C. would be trimmed in this example.

Alternatively, in some embodiments, the data corresponding to the specific length of time at the beginning is identified as the startup hook region. For example, in the above method, the data corresponding to the first minute of the heating may be identified as the startup hook region.

In some embodiments, because at the end of the data there may be a sharp downturn as the DSC switches from heating to cooling, the analyzer module may compensate for this sharp signal drop by trimming 3° C. from the end point. Further, in some embodiments, if the sample is undergoing a temperature modulation, then the initial trimming is performed with an extra 10° C. of data being trimmed from the start, so if the experiment is modulating at a heating rate 5° C./min, then the trimmed temperature span would be the first 15° C. of the heating segment. This difference may be due to the instrumentation lag in reporting the modulation signals and extra time for the material to settle into the modulation of temperature and settle into a steady state.

In some other embodiments, for example, those that perform FSC type of heating, the above method of utilizing the heating rate may not be applied because the sample may be heated at rates well above 100 K/s. Moreover, even in some embodiments in which the heating rate is not high, the difference in sample size and power delivery may lead to differences in startup hook lengths; differences that may not be captured by the above method of using the heating rate and trimming a fixed length of time as the startup hook region. Some such embodiments may instead utilize a custom startup hook estimator based on sample and empty sensor scans to see how far this startup hook reaches based on heating rate. For example, some embodiments may use a linear function such as that shown in Eq. (1) below:

$$f ( R ) = 0.0139 \cdot R + 4.5844 , \qquad ( 1 )$$

in which f(R) is the length of the startup hook to be trimmed in a unit such as Kelvin or centigrade, and R is the heating rate with a unit such as K/s. For example, for the graph shown in FIG. 2, if the heating rate were 2000 K/s, based on Eq. (1), the trim amount would be roughly 32° C. which would trim the data from the first data around −100° C. to around −68° C.

Some embodiments may proceed to identifying the number of phases that the sample undergoes during the heating using different techniques such as those described next.

In some embodiments in which the sample may include material such as a polymer, the sample may undergo three primary phase changes: the glass transition, cold crystallization, and crystal melting. Moreover, in various embodiments, different combinations of these three transitions may happen, and further may occur in any order and multiple times. A classic example is a semi-crystalline polymer observed during heating. After undergoing the glass transition process there is a cold crystallization event that follows. Then those just-formed crystals melt followed by another crystal melting event caused by a different crystal structure or formation. In that example the material has four distinct features. This process can become quite complicated and can start to stack to a large set of combinations.

Another example could include a blend of multiple polymers. In this example if the component materials are not fully miscible the blend may form a complex that has two separate glass transitions and two separate crystalline melts. In such a case, the order of thermal events during heating may be either a.) glass transition 1, followed by melt 1, then glass transition 2, followed by melt 2; or b.) both glass transitions may occur first followed by both melts, in either order of 1 or 2 in their respective phases. Situations may also arise where these melt dynamics are superimposed on top of each other in temperature space. In this scenario, the thermal scan may look like a broad endothermic melt with two distinct peaks but no recovery to a steady state baseline.

Various embodiments may utilize different methods to isolate the difference between the following cases: Case 1—no event at all; Case 2—glass transition process only; and Case 3—complex dynamics: at least one event that is either a crystal melting or a cold crystallization; or more than one event up to any number inclusive of a glass transition. An example of Case 3 would be a semi-crystalline material where both a glass transition and crystal melt occur. Another example of Case 3 would be where multiple melts occur but occur partially overlapping each other.

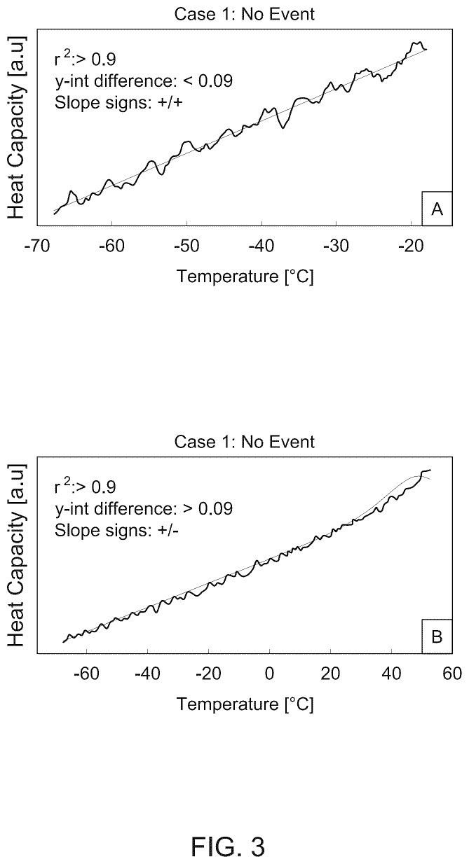

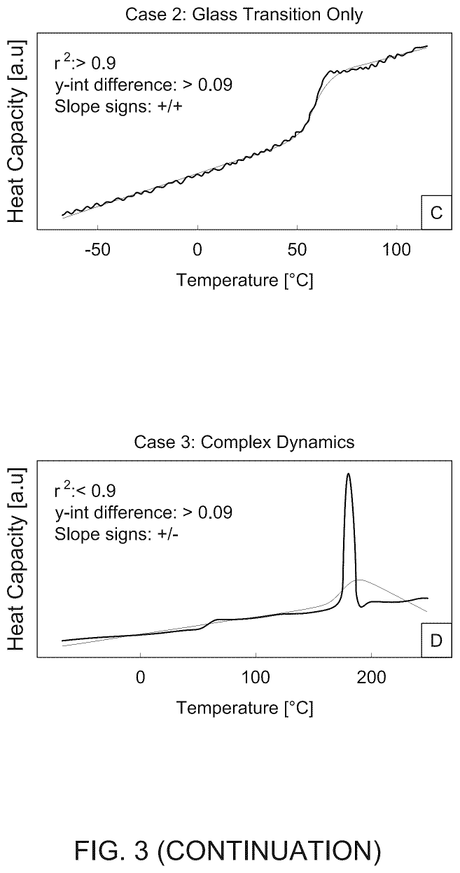

As later described in relation to FIG. 3 and after, some embodiments decide whether a segment of the heating data fits into one of the above cases by fitting the data in the segment to the function shown in Eq. (2) (in some embodiments termed a reference dependence relationship or a reference functional profile):

$$f ( T ) = [ 0.5 + 0.5 \cdot tanh ( - \frac{T - max T}{w} ) ] \cdot ( a \cdot T + b ) + [ 1 - ( 0.5 + 0.5 \cdot tanh ( - \frac{T - max T}{w} ) ) ] \cdot ( c \cdot T + d ) . \qquad ( 2 )$$

In Eq. (2), w, a, b, c, and d are fitting parameters, further referred to below, and maxT is the temperature location of the maximum peak value in the derivative of heat capacity with respect to temperature. In some embodiments, f(T) may be considered a reference dependence relationship between the heat capacity and the temperature, utilized for identifying the phases or phase transitions in the sample during the quality control operation. Further, as seen, f(T) may be considered to include two linear dependences characterized by two linear parameter pairs (a,b) and (c,d); and one nonlinear dependence (the hyperbolic tangent function).

The linear scaling components appended to both hyperbolic tangent functions may serve to rotate the entry and exit slopes of the tangent function to account for the change in state that occurs during the glass transition process. This function may then be fitted to the heating segment. Some embodiments perform the fitting using the MATLAB™ function “lsqcurvefit,” which may be used to solve this nonlinear-least-squares problem.

In some embodiments, the following parameters are required to perform the fit: the function to fit the data (for example, Eq. (2)), the initial guess for the fit parameters (w, a, b, c, and d), the data that are to be fit, and the upper and lower bounds of fit values. In some embodiments, the initial guesses used for the fit parameters are [5,1,1,1,1] for w, a, b, c, and d, respectively. The lower bounds of these parameters may all be set to negative infinity and the upper bounds may all be set to infinity.

In some embodiments, as the next step, once the data are fitted, the analyzer module may calculate some parameters and accordingly decide which one of the above-discussed cases 1-3 may apply to the fit. Consequently, the analyzer module may determine which phases or phase transitions are present in that section of data. The details of the calculated parameters and decision criteria are described next, in relation to the exemplary data fitting cases shown in FIG. 3.

More specifically, FIG. 3 shows four sub-graphs (sub-graphs 3A-3D) corresponding to four different types of segments of heat capacity diagrams fitted with the function f(T) in Eq. 2 with different values of the fitting parameters, according to some embodiments. In each sub-graph, the data in the segment are depicted by the jagged graph and the corresponding fit function is depicted by the smooth solid line. Each of the sub-graphs 3A-3D corresponds to one of the three cases as shown in the title of each sub-graph. Moreover, each sub-graph includes at the upper left the outcome of three criteria based on which the case is determined. Detailed below are the steps that may be taken by the analyzer module to determine the criteria and accordingly determine the case.

First, the analyzer module may perform a fit check. That is, the analyzer module may calculate the r² value of the fit between the data and the function f(T), and accept the fit if r² is greater than the critical value Cr². In various embodiments, Cr² may be in the range, for example, 0.90±0.05, for example 0.85, 0.90, 0.92, 0.95, etc. For example, assuming that the critical value 0.90 is selected, if r² is less than 0.90, then the fit is rejected, and Case 3 is assumed, i.e., the case of the complex dynamics. Therefore, Case 3 corresponds to situations in which the fit check fails.

If, on the other hand, the fit is accepted, then the analyzer module may perform two secondary checks: an intercept check and a slope check. The intercept check includes comparing the two y-intercepts for the two linear branches of the fitting function f(T), which are the fitting parameters b and d. If the absolute value of the difference in the logarithm, in base 10, of the y-intercepts is greater than a minimum significant difference Δly, then the intercept check is accepted, and otherwise rejected. Generally, if the difference is greater than Δly, then the two y-intercepts may be considered to be significantly different. In some embodiments Δly may be in the range 0.10±0.05, such as 0.05, 0.07, 0.10, 0.12, etc. In some embodiments, an optimal value for Δly have been found to be around 0.06.

The slope check, on the other hand, includes determining whether the slopes, i.e., fitting parameters a and c, have the same signs. That is, if the slopes are either both positive or both negative, the slope check passes and otherwise fails.

If either of these two secondary checks (the intercept check or the slope check) fails then a Case 1 is reported, that is, the case of no event. If, on the other hand, both secondary checks pass, then a Case 2 is reported, that is, a case of glass transition only.

The above Cases are depicted in the 4 subgraphs of FIG. 3. Here, in particular, sub-graph 3A corresponds to the case in which the y-intercept difference is low (intercept check fail) while the two slopes have the same positive signs (slope check pass). Sub-graph 3B, on the other hand, corresponds to the case in which the y-intercept difference is high (intercept check pass) but the slopes have different signs (first positive then negative, therefore, slope check fails). Thus, both sub-graphs 3A and 3B correspond to Case 1, no event, as indicated in their titles. That is, the analyzer module determines that no event is present in the two segments of data shown in these two sub-graphs.

Sub graph 3C, on the other hand, represents the case in which all three tests have passed (satisfactory r², critical y-intercept difference, and sign of the slopes matching, here both positive). Therefore, the analyzer module may determine that the data in this sub-graph corresponds to Case 2, glass transition only. That is, those data indicate the occurrence of a glass transition.

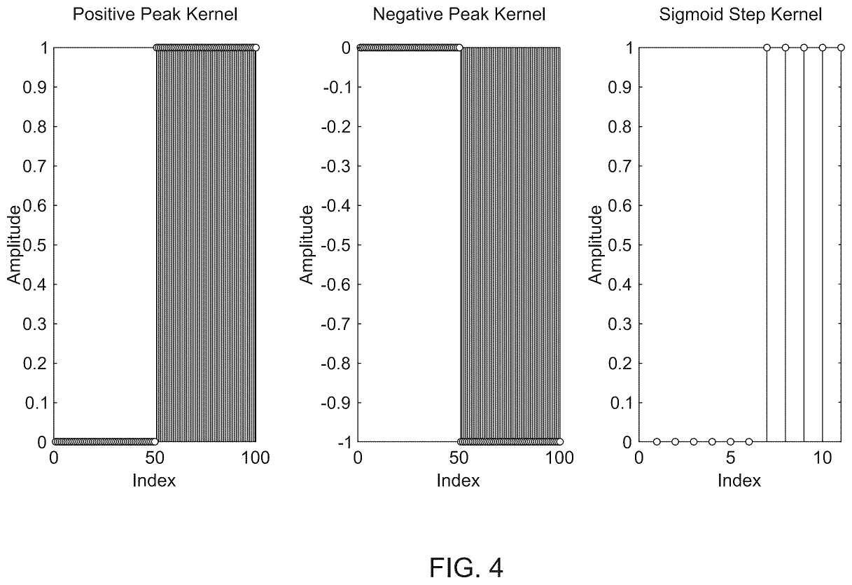

In sub-graph 3D, on the other hand and as explained above, the fit test has failed. That is, in this case, r² is less than the critical value Cr² (here 0.9) based on which the fit has been rejected and the data have been associated with Case 3, i.e., indicating a complex dynamics. In some embodiments, for such a case, the analyzer module may perform some further analyses to, for example, isolate possible different dynamics that may occur in case 3. Those further analyses may include applying a series of convolution filters, as further detailed below in relation to FIG. 4.

More specifically, FIG. 4 shows application of three different convolution kernels for detecting three different types of phase transitions according to some embodiments. In FIG. 4, the left panel is used for the determination of crystal melt structure, the middle panel detects cold crystallization, and the right panel detects glass transition processes. To that end, a series of step functions based on the expected width of a given transition and transition direction are passed through the full spectrum. This convolution process may isolate the dynamics above the noise level of the signal. In particular, in FIG. 4, the three convolution kernels are presented as, from left to right, melt peak kernel, cold crystallization kernel, and glass transition process kernel.

In some embodiments, the sigmoidal kernel, though similar to the positive peak kernel, is applied to a convolution performed on the first derivative of the heat capacity with respect to temperature. In this derivative space a sigmoidal like step change would appear as a peak that, when coupled with the narrow filter, may be easily resolved. From here the sigmoidal filter may still magnify any signal of cold crystallization and melting but by using spatial rejection these peaks will not be double counted. In some embodiments, this rejection may be based on both the distance to the peaks found in the positive and negative peak kernel convolutions, and the thresholding based on the calculated rms of the first 10° C. of the signal and the rms of the total convolution curve. In this way, the true glass transition peak may be isolated.

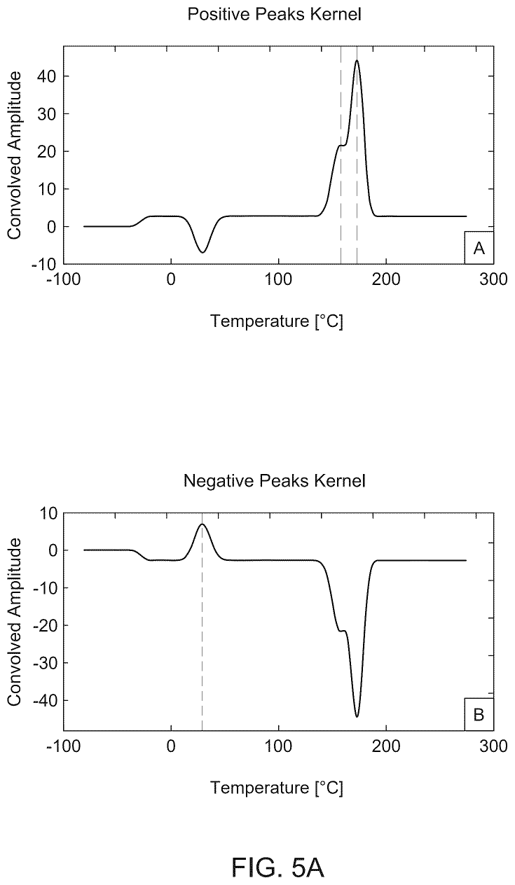

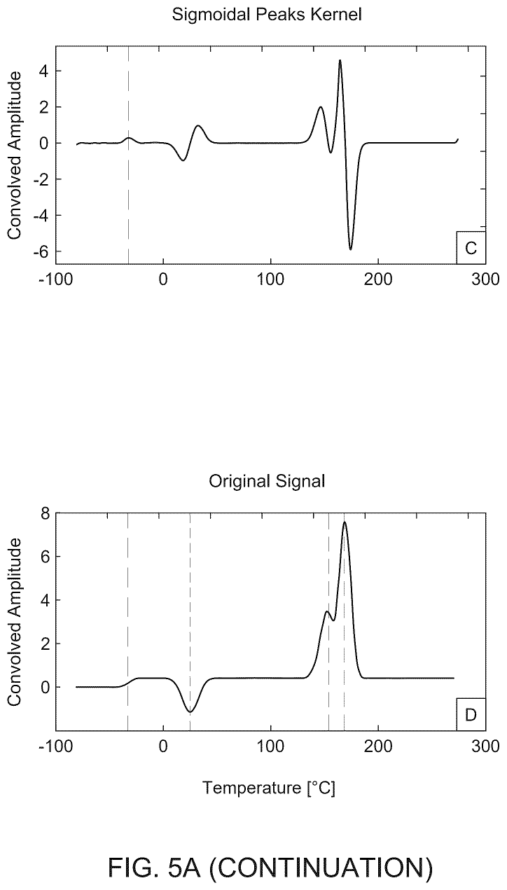

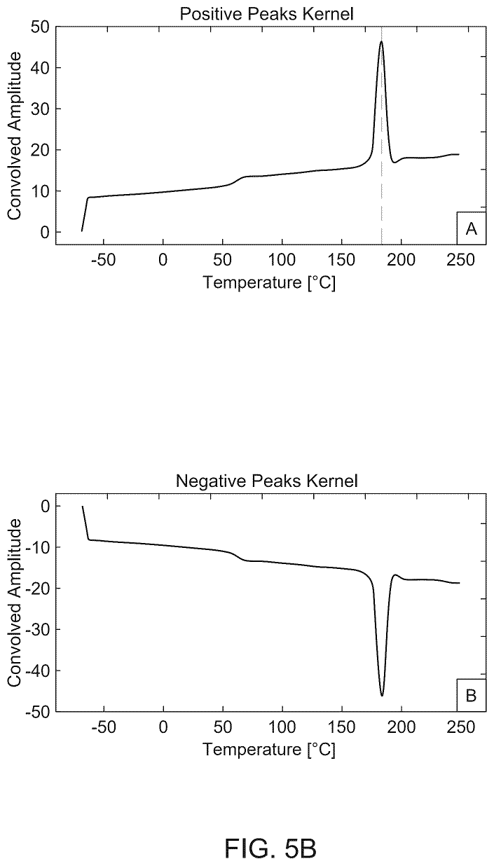

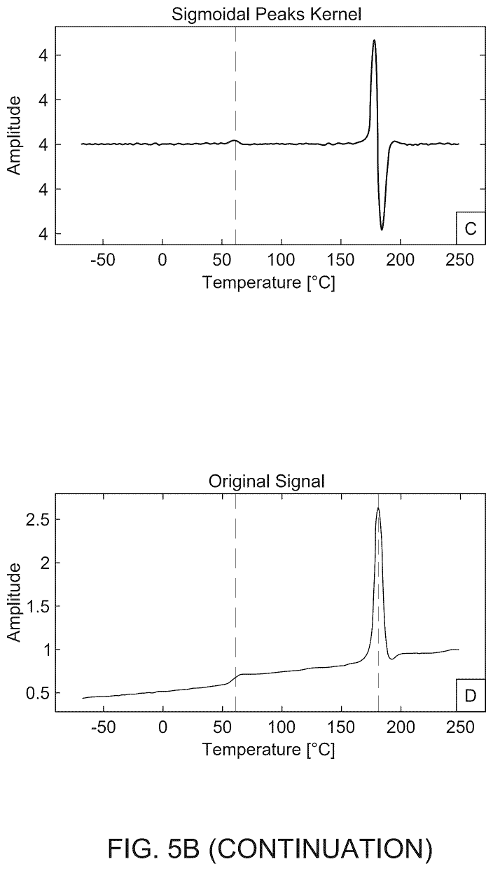

FIG. 5A shows four different examples of convolution analysis of simulated heat capacity data according to some embodiments. More specifically, FIG. 5A demonstrates the outcome of the filtering process in an embodiment for a material that contains a glass transition, cold crystallization exotherm, and two melting endotherms partially overlapping each other. This example uses artificial data, presented for illustrative purposes, created under the following conditions: steady state baselines are constant with zero slope, peaks are Gaussian, and glass transitions are hyperbolic tangents but do not have varied angles of entry and exit. Once each dynamic is isolated, the indices corresponding to each may be sorted in ascending order to determine the order of events.

FIG. 5A includes 4 panels (panels A-D). Panels A-C show normalized convolved amplitude as a function of temperature. In particular, in panel A, positive peak kernel convolution confirms the double melting endotherm structure (marked by the 2 vertical lines located between 100° C. and 200° C.). In panel B, the negative peak kernel highlights the single peak corresponding to cold crystallization exotherm (marked by the vertical line located between 0° C. and 100° C.). In panel C, the sigmoidal peak kernel shows the single peak referring to the glass transition (marked by the vertical line located between −100° C. and 0° C.). Panel D shows a culmination of all events, identified by vertical lines at the locations derived in panel A-C, shown overlayed with the original spectrum (smooth curve).

The effectiveness of this procedure may be further demonstrated by its application to real experimental data for the PLLA sample described and shown above in graph diagram 200 of FIG. 2. To that end, FIG. 5B shows four different examples of convolution analysis of experimental heat capacity data derived for the PLLA sample according to an embodiment. More specifically, FIG. 5B depicts the results of analyzing those real experimental data by the application of processes similar to those described in relation to FIG. 5A according to some embodiments. In this case, when the three filters are applied to the heating spectrum, the positive peaks kernel (panel A) and the sigmoidal peaks kernel (panel C) each return an event detection (marked by the vertical line located between 150° C. and 200° C. in panel A, and the vertical line located between 50° C. and 100° C. in panel C). These events respectively correspond to a crystal melting and a glass transition. The negative peak kernel analysis of panel B, on the other hand, has not detected any event, indicating that in this case a cold crystallization may not be present.

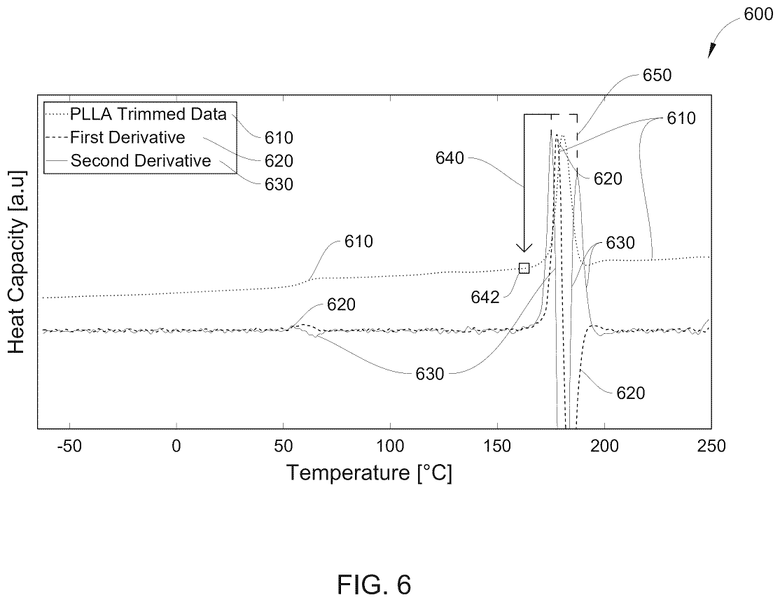

Some embodiments further include a two-phase model analysis that may include the glass transition event as further detailed below, in relation to FIG. 6.

More specifically, FIG. 6 shows a graph set 600 that includes various graphs derived from heat flow to heat capacity for determining a solid-state baseline according to some embodiments. In particular, graph set 600 includes a heat capacity graph 610 corresponding to the heat capacity data as a function of temperature for PLLA. Heat capacity graph 610, therefore, corresponds to the same data shown in graph diagram 200 after deletion of the startup hook region.

Graph set 600 further includes a first derivative graph 620 showing data for the first derivative of heat capacity graph 610 with respect to the temperature. Graph set 600 also includes a second derivative graph 630 showing data for the second derivative of heat capacity graph 610 with respect to the temperature. In graph set 600, arrow 640 points to a square 642 on the original data, which corresponds to the temperature location on heat capacity graph 610 that is shifted to the left of the first positive peak in the second derivative by an amount equal to the temperature span between the first and second positive peaks in the second derivative (dashed line 650). Square 642 may be used as a stopping position for the longest fit attempt to be performed, because higher temperatures may be considered within the melting peak range.

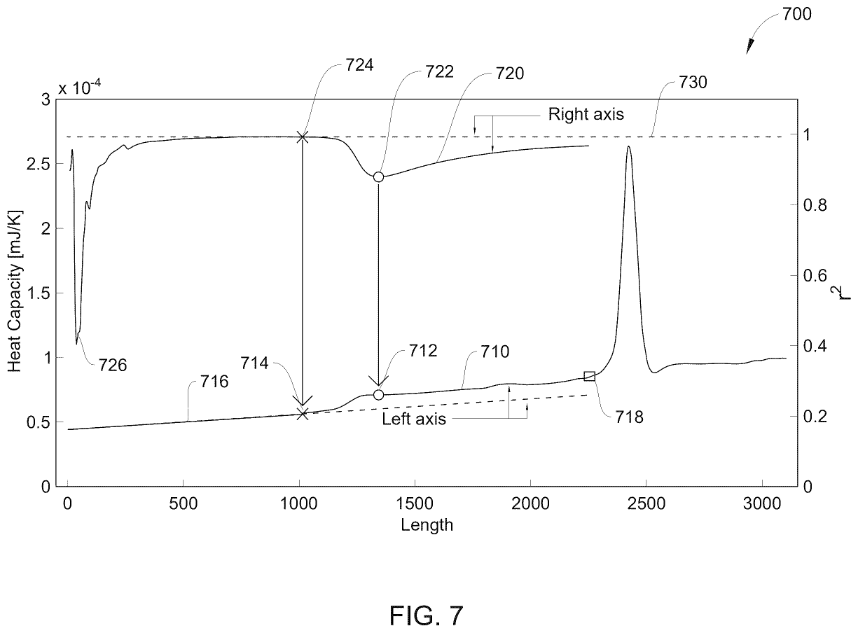

The analyzer module may then analyze the glass transition utilizing a linear fit analysis as detailed below. FIG. 7 includes a graph set 700, which demonstrates some results of the linear fit analysis performed on the heat capacity data according to some embodiments. In particular, in some embodiments, when analyzing the glass transition event, the first step may include finding the best solid-state baseline (such as the region labeled as solid-state in FIG. 2, located roughly between around −70° C. and 40° C.). A series of successive linear fits may be performed starting at a minimum fit length corresponding to, for example, 1° C. change in temperature. The fits may then increase in length from the same starting point. Each fit may grow by one data point until the fit length reaches a point defined by the characteristics of the second derivative peaks. This end point (or maximum fit length attempted) is shown by square 642 in FIG. 6 and is defined so as to avoid the region of the melting endotherms. In some embodiments, the analyzer module may use the characteristics of the second derivative to determine the end point, by moving a certain distance away from the first peak of the second derivative. In some embodiments the distance may be determined based on the separation distance between the first and second positive peaks of the second derivative. The distance may be set to be equal to that separation or a factor (such as 1.1, 1.5, 2, etc.) times that separation. In FIG. 6, the separation in peak positions is highlighted by dashed line 650, while arrow 640 shows the leftward shift equal to that separation and its temperature location 642 on the PLLA data.

The analyzer module may then perform successive linear fits for the region defined by the first data point in the trimmed heating segment (for example, the leftmost data point in FIG. 6) up to the location of square 642 in FIG. 6Error! Reference source not found. For each successive linear fit, the analyzer module may calculate the r² value. The r² values may then be analyzed to find the longest good fit of the data before the glass transition event. Performing successive fits may result in erratic changes in quality of fit when the lengths are small but as the fits begin to grow, the r² value of these linear fits will start to stabilize.

In FIG. 7, the horizontal or x-axis shows the linear fit length or index values. The y-axis, on the other hand, indicates 2 different quantities for the 2 graphs in graph set 700. In particular, graph set 700 includes a heat capacity graph 710 and a fit value graph 720.

Heat capacity graph 710 shows the heat capacity of PLLA, with values shown on the left vertical axis, plotted as a function of the linear fit length (or index).

Fit value graph 720, on the other hand, shows the r² value, with values shown on the right vertical axis, plotted as a function of the linear fit length. Any data point on fit value graph 720 (two are shown, by data points 722 and 724) can be mapped to a linear fit that starts at index 0 and goes to the x value of that data point. This can be seen in FIG. 7 by a point 724, which marks the spot on fit value graph 720 for a given fit value (around value 1 marked by the dotted line 730) which corresponds to the length of the fit traced out by a line segment 716 overlaying heat capacity graph 710 up to point 714 (which corresponds the same fit length, around 1000, as point 724 on fit value graph 720.

There may exist two factors in deciding what a “good” fit is. One is the actual r² simply put, the closer to 1 the better. The second is the length of the linear fit. In general, a longer linear fit should better represent the data. However, if the fits span a temperature range that is too wide, the actual transition itself may be captured. Looking closely at the r² values, the lowest fit result is about 0.45 (marked by minimum point 726 located around length or index 40), but most fits lie above ˜0.9. This means a metric that looks only at a combined scoring of length and r² will ultimately just return the longest fit since the region from index 0 to ˜2200 can be very fairly represented as linear.

There may exist two repeatable trends in r² when analyzing the running fits of these types of heat capacity curves. The first trend is the initial drop at point 726, here around index 40, which is due to the heavy influence of noise when fitting across short temperature spans. The second trend is the drop that occurs in r² (culminating at point 724, when moving leftward from high index values, as explained below) when fitting through the glass transition itself. The bottom of that drop is indicated by point 722 located around index 1350. There is a region in between these two points, index 40 and index 1350, which is the stabilized region and is highlighted by a plateau in r² that is in contact with Dotted line 730. Dotted line 730 depicts the mode of the r² values rounded to the thousandths place and in this case has a value close to 1. Then, the indexing may start from the right side of fit value graph 720 moving leftward and find the first data point that meets the dashed line, which is marked here by point 724. This point is considered as an upper limit, marking the end of the longest “good” fit describing the solid state.

Therefore, in summary, FIG. 7 on the left y-axis shows the values of the heat capacity as a function of index (fit length) for experimental PLLA data (heat capacity graph 710), including the solid-state baseline (line segment 716), linear extrapolation of the solid state to higher temperature (dashed line extending line segment 716), the start of the glass transition region (point 714), and the end of the glass transition (point 712).

Right y-axis, on the other hand, shows the values of the running linear fit r² as a function of fit length (fit value graph 720). A stabilized region is shown in roughly by the part of the fit curve in contact with dotted line 730. Key points are marked to show the start of the glass transition (point 724) and the end of the glass transition (data points 722). These two points are mapped to heat capacity graph 710 following the vertical arrows. A maximum fit point 718, shown by a square around index 2300, marks the longest segment of data fit (corresponding to square 642 in FIG. 6).

Data point 722, which is at the minimum of the second drop in r² (i.e., a minimum or, as here, a local minimum in the fit) occurring here at around a length of 1350, may be referred to as the “recovery point”, or the end of the glass transition. This method of finding the start and end of the glass transition may be applicable to the case of enthalpic relaxation as well. Such a case may be seen in the PLLA data where there is a small enthalpic overshoot at the end of the glass transition, just before settling into the rubbery/semi-solid state occurs.

In some embodiments, fitting the rubbery/semi-solid state may be complicated by the fact that it may be tied closely to the liquid state. A crystalline polymer's melting endotherms are generally non-symmetric, non-Gaussian, and have a non-uniform baseline position between the left and right sides. This complexity may pose difficulties when using a statistical change point analysis or peak fitting.

In some embodiments, the analyzer module may address the above difficulties by taking the first and second derivatives to determine the general width and asymmetry. FIG. 6 shows the normalized first and second derivatives of the apparent heat capacity with respect to temperature. The separation in the peaks of the second derivative can be treated in a manner akin to the full width at half maximum. This allows for the asymmetry and non-Gaussian shape to be almost neglected, and isolation of the melting peak from its inception in the rubbery/semi-solid to its completion in the liquid state can be performed. The fitting begins from the end of the glass transition and extends toward the melt peak. The longest fit ranges from the end of the glass transition process to the first peak of the second derivative. For the liquid state, the analyzer module may begin fitting from the high temperature end of the data, at the right, and work backwards moving toward the second peak of the second derivative.

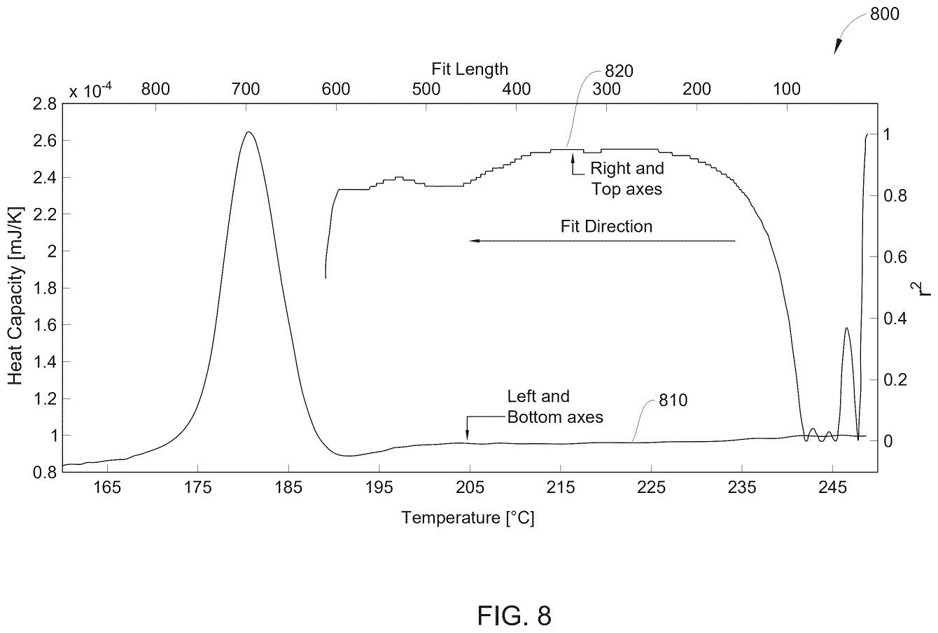

FIG. 8 includes a graph set 800 that illustrates the liquid state fitting according to some embodiments. More specifically, graph set 800 includes a magnified view of the liquid state region of the PLLA data (liquid state graph 810) plotted along with the running r² fit graph 820 of the successive linear fits. The bottom horizontal axis (corresponding to liquid state graph 810) represents the temperature while the top horizontal axis (corresponding to fit graph 820) represents the fit length of each fit attempt. The top horizontal axis increases from right to left to signify the direction of the fit whose length increases toward the second peak of the second derivative (i.e., fits begin at high temperature and grow in fit length toward lower temperatures). The liquid state linear fit r² values are rounded to the hundredths place to smooth out the noise caused by the shorter fits and noisy data.

The analyzer module may repeat this process for the rubbery/semi-solid state defined as the region that follows the glass transition and stops before the crystal melting endotherm. However, determining the points on either side of the melting peak that are the end or start of a region of steady state behavior (end of rubbery/semi-solid state/start of melting process, and start of liquid state/end of melting process) may cause difficulties. Underlying the melting peak may be a changing, non-linear baseline. This non-linear baseline may be a result of now-melted crystals that are in the liquid state and are garrison motels contributing to the lifting of the melt peak. This lifting of the melt peak is what causes the increased steady-state heat capacity in the liquid state since the final liquid state baseline has a higher heat capacity than the rubbery/semi-solid or solid-state baselines. The rate at which material transitions from rubbery/semi-solid or solid to a liquid during the melting process may be non-linear due to the latent heat in the material while the environment temperature is changing around it. To account for this transition underneath the melting endotherm the analyzer module may apply the same hyperbolic tangent function, i.e., f(T) of equation (2), that was used in the glass transition event analysis.

In particular, the analyzer module may start with a given rubbery/semi-solid state baseline fit attempt, pairing with each individual liquid state baseline fit attempt that has an r² greater than 0.9. For each pairing a full baseline may be made, extending from the start of the rubbery/semi-solid state to the end of the liquid state, using the parameters of the linear fit for both the rubbery/semi-solid state and the liquid state. These parameters are then used for equation (2), where the variables are: maxT—peak temperature of the melt peak; a and b—the slope and y intercept, respectively, of the rubbery/semi-solid state baseline; c and d—the slope and y intercept, respectively, of the liquid state baseline; and w—half the temperature span between the two positive peak positions in the second derivative. The independent temperature variable, T, ranges from the start of the rubbery/semi-solid state baseline to the end of the liquid state baseline.

Conventional methods and systems generally do not account for variations of the entry and exit slopes into the melting region, which in extreme cases can lead to drastic differences in the determination of the area of the melt peak. Some of those techniques perform sigmoidal fitting by projecting the baseline from the steady-state parallel to the x-axis (i.e., horizontally), inflecting at the peak maximum position and joining the liquid state, again along a line parallel to the x-axis.

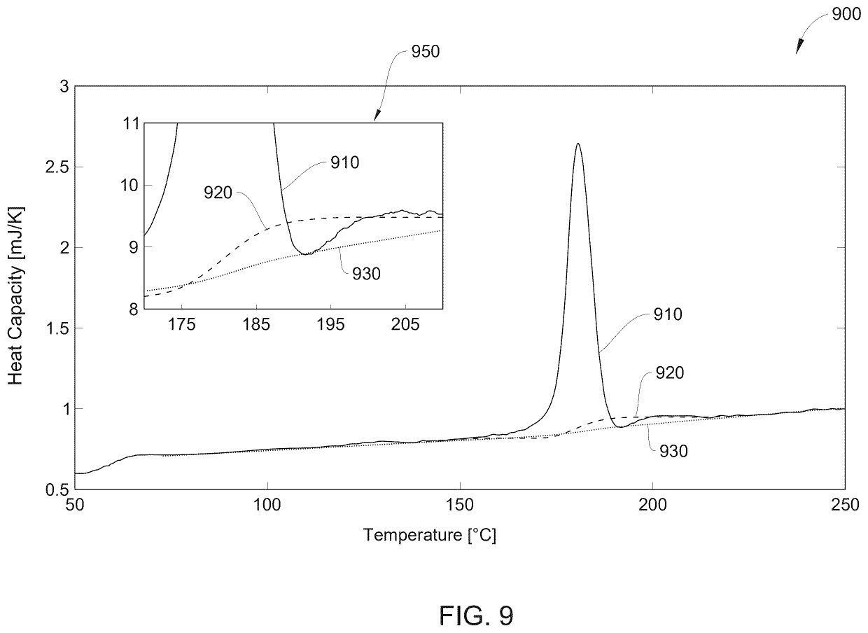

FIG. 9 shows a graph set 900, which illustrates the difference between the conventional method and the improved techniques according to some embodiments.

More specifically graph set 900 includes a graph 910 showing the apparent heat capacity as a function of temperature for the PLLA sample that has been analyzed, a conventional results graph 920 showing the results derived by the conventional techniques, and an improved results graph 930 showing the results derived by the improved techniques in accordance with some embodiments. The conventional approach, just described, employs a horizontally projected sigmoidal step, which lacks precision in capturing secondary melt structures and leads to significant discrepancies in estimating the heat of fusion from the peak area.

Therefore, in graph set 900, improved results graph 930, which utilizes a full sigmoidal baseline from the rubbery/semi-solid state to liquid state, shows significant improvement when compared to the conventional method using horizontal tangents as shown in conventional results graph 920.

Graph set 900 further includes an inset 950, which shows a magnified view of the truncated melting endotherm. Inset 950 shows the significance of the separation of the two baselines when both the inflection point and width are held the same. Inset 950 illustrates how the horizontal projection method truncates the second melting peak, which ranges from ˜190-215° C., whereas the new method seamlessly extends from the turning point to the liquid state, rejoining the liquid state at around 215° C.

Using this new baseline, the determination of the total melt enthalpy may be performed by finding the area bounded by the start of the rubbery/semi-solid state and the end of the liquid state, between the real data and the hyperbolic tangent baseline.

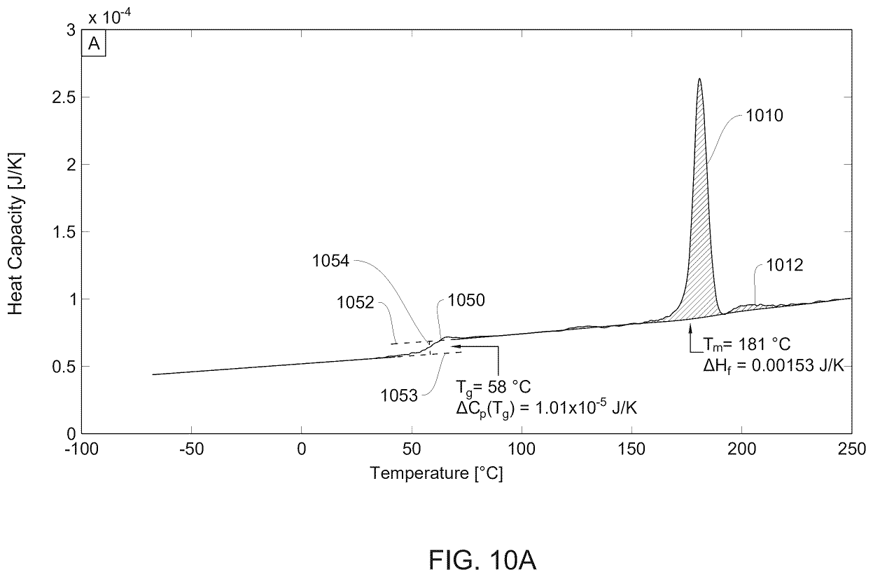

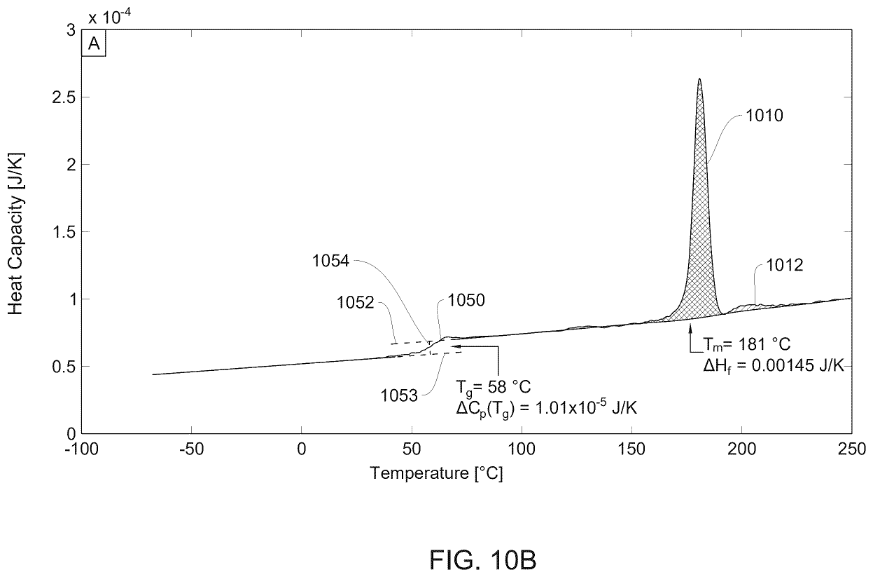

FIGS. 10A and 10B illustrate some of the improvements achieved in determination of the total melting heat utilizing the new techniques according to some embodiments. As illustrated, two areas are calculated. The first is the area previously described and is what is shown by areas under peaks 1010 and 1012 in FIG. 10A. This is the complete area across the rubbery/semi-solid and liquid states. The second area is the focused melting peak area, which is defined by the area under a peak 1010 in FIG. 10B. This area is defined by the last point of contact between heat capacity curve 1050 and baseline 1052 entering the melting peak (on the low temperature side) and the first point of contact with the tangent baseline coming down from the peak of the melting endotherm into the liquid state (on the high temperature side).

More specifically, FIG. 10A shows that in the conventional techniques the total melting endotherm area is calculated between baseline 1052 and the experimental heat capacity curve 1050 in the range from 70° C. to 250° C., which in particular includes both areas under peak 1010 and peak 1012. FIG. 10B, on the other hand, shows that the improved thickening calculates the focused integral area corresponding to the primary melting peak (peak 1010) in the range from 154° C. to 190° C. The total heat absorbed determined from the melting peak area and peak melting temperature are reported under the peaks in FIGS. 10A and 10B. Horizontal dashed lines 1052 and 1053 indicate the glass transition region with the vertical dashed line 1054, located around 58° C., indicating the glass transition temperature (Tg) calculated using the Moynihan method. The heat capacity increment at Tg is reported as well. In some embodiments, the improvement in part relates to taking into account the area under peak 1012, which is missed by conventional methods.

The analyzer module may choose the final baseline through a two-step process for scoring. The first step starts with a given rubbery/semi-solid state which is then paired with every liquid state fit. A sigmoidal baseline is generated, and the area is calculated. This is repeated for every rubbery/semi-solid state fit until all rubbery/semi-solid state fits are paired with all liquid state fits. After this pairing, the peak areas are normalized, with the largest area being normalized to 1 and the smallest area being normalized to −1. The ideal peak area is the one closest to 0. This does not inherently incentivize steep slopes in either baseline or in either direction. The smallest peak areas arise when the rubbery/semi-solid state baseline is “steep” and the liquid state baseline is “shallow.” This will cause the melting peak area to become clipped off as the total baseline cuts through the sharp rise of the left side of the melting peak. When the slope of the rubbery/semi-solid state baseline is too shallow, and the liquid state baseline is steep, the resulting area is too large, thereby incorrectly identifying the melting region defined by the region under peak 1010 in FIG. 10B. This inflation of the region would result in reporting of a lower temperature for the start of melting and a higher temperature for the end of melting. Finally, the last effect occurs when both of the slopes, of the rubbery/semi-solid state and of the liquid state, are steep. When this occurs, the sign of the hyperbolic tangent function will change and the baseline inflection will become a downward step from left to right.

To mitigate these extremes, the analyzer module may perform the initial trimming of the rubbery/semi-solid state and liquid state baselines for fits that have an r²<0.9. This initial trimming almost negates all the extreme effects since the fits of poor quality tend to have “extreme steepness” in slope. From all the fit attempts made, the analyzer module may select as the best fit the normalized area that is closest to 0 the greatest number of times. Beginning with a given rubbery/semi-solid state fit, the area under the melting peak is then calculated from each pairing with each liquid state fit. For that first rubbery/semi-solid state fit, the liquid state fit that resulted in a normalized peak area of 0 (or closest to zero) is kept. This is then repeated for each of the remaining rubbery/semi-solid states and all their possible combinations with liquid states. Once all rubbery/semi-solid states have been checked, the liquid state fit that was reported as the ideal pairing the greatest number of times is then recorded.

The second step involves looking from the liquid state perspective back toward the rubbery/semi-solid state (i.e., looking down in temperature), and repeating the sigmoidal fits to find the rubbery/semi-solid state baseline that produces the best fit. Finally, results of these two steps are combined to return the best overall fit.

Once the final baselines are determined for the rubbery/semi-solid and liquid states, determination of Tg and heat capacity increment at Tg may be performed. This is done using the Moynihan method of equal areas across the glass transition region. In FIGS. 10A and 10B the glass transition region is highlighted by the dashed lines extending from both the solid state and rubbery/semi-solid state baselines. The glass transition temperature (or fictive temperature, in the case of structural relaxation) is computed using the Moynihan method. The limits of integration span temperatures above and below Tg. The relative width of the glass transition process is determined by the temperature span between the end of the solid-state fit, in this case from 41° C. up to the start of the rubbery/semi-solid state at 71° C. From here the limits are extended in each direction by half of the width. In the end the limits of integration of the glass transition region in this example range from 26° C. to 86° C. The glass transition temperature is then calculated to be 58° C., and the change in heat capacity at Tg is determined to be 1.01×10⁻⁵ J/K.

The total heat absorbed during melting is calculated by taking the integral under the heat capacity curve in two different ways. The first is the total area from 71° C. to 250° C. with a peak melt temperature, Tm, of 181° C. and change in enthalpy of ΔH of 1.53×10-3 J. However, using only the region under peak 1010 in FIG. 10B, the ΔH is 1.45×10-3 J with a Tm of 181° C. The corresponding area may be defined by the last contact point of the rubbery/semi-solid state with the baseline entering the melt area and the first contact point with the baseline exiting the melt area and entering the liquid state. The difference in melting peak areas is attributed to the secondary thermal event observed in the region of 195-215° C. This secondary event has a ΔH of 0.08×10⁻³ J.

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud,” to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

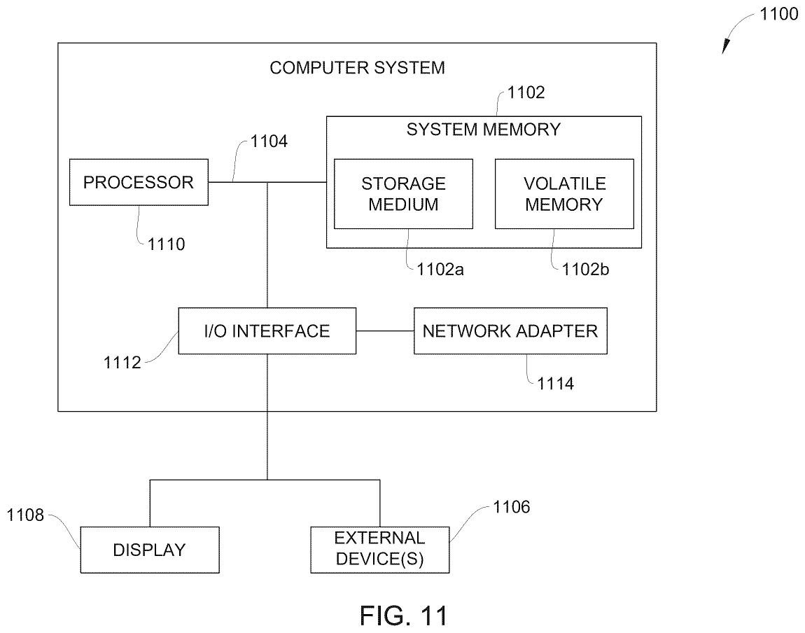

By way of example, FIG. 11 schematically depicts an example of an implementation of a module 1100 according to some embodiments. Module 1100 includes a system memory 1102 that may include a permanent memory module (e.g., ROM 1102a) and a transient memory module (e.g., RAM 1102b), an internal bus 1104, a processor 1110 (e.g., a microprocessor), an I/O interface 1112, and a communication interface 1114 (such as a network adapter). I/O interface 1112 may be in communication with one or more external input devices 1106 (such as a mouse, a keyboard, or a touch screen) or output devices 1108 (such as a display, a printer, or a speaker).

Processor 1110 and the system memory 1102 may be utilized to store and execute instructions performing the function of module 1100. Moreover, internal bus 1104 may enable communication between the processor and other parts of module 1100 such as system memory 1102, I/O interface 1112, or communication interface 1114.

Some or all of the method steps may be executed by (or using) a hardware apparatus, like for example, a processor, a microprocessor, a programmable computer, or an electronic circuit.

Depending on certain implementation requirements, embodiments of the disclosure may be implemented in hardware and/or in software. The implementation may be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill will appreciate that various changes may be made to the above embodiments without departing from the scope of the disclosure.

Although some aspects have been described in the context of a system or an apparatus, it is clear that these aspects may also represent a description of the corresponding method, where a block or device corresponds to a method step or a feature of a method step. Analogously, aspects described in the context of a method step also represent a description of a corresponding block or item or feature of a corresponding apparatus.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature exists in one or more embodiments but not necessarily in all embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or.

Moreover, if these terms are used, a set may include one or more members, and a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed compositions, systems, methods, and apparatus are not limited to any specific aspect or feature or combinations thereof, nor do the disclosed compositions, systems, methods, and apparatus require that any one or more specific advantages be present or problems be solved. Any theories of operation are to facilitate explanation, but the disclosed compositions, systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

Some further details of some embodiments are included in the attached six-page article, submitted as an appendix to this disclosure, titled “A novel and robust method for automated capacity analysis of polymeric calorimetric data”

What is claimed is:

1. A system comprising:
a sample heater configured to heat a sample and to determine a plurality of heat amounts applied to the sample at a plurality of times in a time interval;
a temperature sensor configured to determine a plurality of temperatures of the sample at the plurality of times; and
an analyzer module configured to:
receive information indicating the plurality of heat amounts and the plurality of temperatures as functions of the plurality of times; and
identify at least one phase transition in the sample during the time interval.

2. The system of claim 1, wherein the analyzer module is further configured to:
determine a heat capacity-temperature dependence including a plurality of heat capacity values as a function of the plurality of temperatures; and
compare the heat capacity-temperature dependence with a reference dependence relationship to identify the at least one phase transition.

3. The system of claim 2, wherein the dependence relationship includes a first linear dependence on the temperature, a second linear dependence on the temperature, and a nonlinear dependence on the temperature connecting the first linear dependence to the second linear dependence.

4. The system of claim 3, wherein the comparing identifies an event.

5. The system of claim 4, wherein the event includes a second order phase transition.

6. The system of claim 5, wherein the second order phase transition includes a glass transition.

7. The system of claim 4, wherein the event includes a first order phase transition.

8. The system of claim 7, wherein the first order phase transition includes a melting.

9. The system of claim 2, wherein:
the dependence relationship includes a linear dependence; and
the analyzer module is further configured to:
determine a maximum range for fitting the heat capacity-temperature dependence with the linear dependence; and
accordingly determine an onset of a glass transition.

10. The system of claim 9, wherein the analyzer module is further configured to determine an end of the glass transition based on a point of minimum fit.

11. A method for determining phase transitions of a sample over a temperature range, comprising using a microprocessor to perform:
identifying a plurality of phases of the sample and their relative order as a function of temperature over a temperature range;
receiving heat-temperature data corresponding to temperature of the sample at a plurality of temperature values and values of a heat-related variable indicative of an amount of heat required to raise a temperature of the sample to each of the temperature values;
identifying a transition between at least two of the phases by fitting the heat-temperature data as a function of increasing or decreasing temperature to a reference functional profile; and
utilizing a defined quality of fit criterion to identity at least one temperature associated with the transition.

12. The method of claim 11, wherein the heat-related variable comprises a heat capacity of the sample.

13. The method of claim 12, wherein:
a first one of the at least two phases is characterized by a linear relationship between the heat capacity and the temperature; and
a second one of the at least two phases is a rubbery/semi-solid phase separated from the first phase by a glass transition.

14. The method of claim 13, wherein:
the reference functional profile includes a linear section; and
the quality of fit criterion is a linear fit.

15. A method comprising:
utilizing an analyzer module for performing:
receiving information including:
a plurality of heat amounts applied to a sample at a plurality of times in a time interval; and
a plurality of temperatures of the sample at the plurality of times; and
identifying at least one phase transition in the sample during the time interval based on a relation between the plurality of heat amounts and the plurality of temperatures.

16. The method of claim 15, further comprising:
utilizing a sample heater to heat the sample and to determine the plurality of heat amounts applied to the sample at the plurality of times; and
utilizing a temperature sensor to determine the plurality of temperatures of the sample at the plurality of times.

17. The method of claim 15, further utilizing the analyzer module to perform:
determining a heat capacity-temperature dependence including a plurality of heat capacity values as a function of the plurality of temperatures; and
comparing the heat capacity-temperature dependence with a reference dependence relationship to identify the at least one phase transition.

18. The method of claim 17, wherein the dependence relationship includes a first linear dependence on the temperature, a second linear dependence on the temperature, and a nonlinear dependence on the temperature connecting the first linear dependence to the second linear dependence.

19. The method of claim 18, wherein the comparing identifies an event.

20. The method of claim 19, wherein the event includes a second order phase transition.

21. The method of claim 20, wherein the second order phase transition includes a glass transition.

22. The method of claim 19, wherein the event includes a first order phase transition.

23. The method of claim 22, wherein the first order phase transition includes a melting.

24. The method of claim 17, wherein:
the dependence relationship includes a linear dependence; and
the method further comprises utilizing the analyzer module to perform:
determining a maximum range for fitting the heat capacity-temperature dependence with the linear dependence; and
accordingly determining an onset of a glass transition.

25. The method of claim 24, the method further comprising utilizing the analyzer module to perform determining an end of the glass transition based on a point of a minimum fit.
